(19) United States
(12) Patent Application Publication
(10) Pub. No.: US 2008/0304141 A1
(43) Pub. Date: Dec. 11, 2008

(54) Optical Image Converter Arrangement

(76) Inventor: Mark Diem, Grossbottwar (DE)

Correspondence Address: COLLARD & ROE, P.C., 1077 NORTHERN BOULEVARD, ROSLYN, NY, 11576, US

(21) Appl. No.: 11/658,343

(22) PCT Filed: Aug. 3, 2005
(86) PCT No.: PCT/EP05/08388

§ 371 Date: Jan. 24, 2007

(30) Foreign Application Priority Data
Aug. 4, 2004 (DE) 10 2004 038 019.8

(51) Int. Cl. G02B 21/36; G02B 23/24

(52) U.S. Cl. 359/362; 359/363

(57) ABSTRACT

The invention relates to an optical image converter system to be used in video cameras. The image converter system comprises a recording lens that is to be oriented towards an object and generates a real intermediate image of the object with a defined image size and depth of focus on a first translucent projection disk defining a first image plane. The inventive image converter system further comprises a prism arrangement that is positioned in the beam path as well as an image converter lens which is disposed behind the recording lens in the beam path, is oriented towards the rear face of the projection disk, and is used for generating a real main image of the object on a second image plane. In order to design the image converter system in a compact manner, the projection disk is placed in an intermediate space between two facing, parallel prism surfaces within the prism arrangement.

The invention relates to an optical image converter arrangement having a recording lens to be oriented at an object, for producing a real intermediate image of the object, with a defined image size and depth of focus in a first image plane, having an image converter lens disposed behind the recording lens in the beam path, directed at the first image plane, for producing a real main image of the object in a second image plane, and having a prism arrangement situated in the beam path, whereby a light-permeable projection disk is disposed in the first image plane.

An image converter arrangement of this type is known (EP 0 950 912 A2), in which a projection disk is disposed behind a recording lens in a lens tube, onto the back of which disk an image converter lens is directed, in the image plane of which a photographic film or a CCD image receiver of a video camera is disposed. The intermediate image produced in the first image plane by way of the recording lens is projected onto the second image plane with an image size and/or image format that is changed relative to the intermediate image, by way of the image converter lens. Such an arrangement allows the use of relatively large image formats, for example with a side length of 16, 32 or 70 mm in the region of the first image plane, and therefore the use of a commercially available film camera lens for such a format. In this way, camera settings with a low depth of focus can be achieved, which are not possible with current video cameras having a relatively small receiver chip. Furthermore, the image converter lens assures that the intermediate image can be projected onto the small video chip of a video camera, and recorded there, in its full brilliance and with the predetermined depth of focus. The image converter arrangement also makes it possible for images and films to be produced using a video camera, which normally can only be done using large film cameras. In this way, a cameraman is given the opportunity to record video films that lead to professional results even without the use of expensive film materials. These results consist, in particular, in the fact that a depth of focus that is variable within a broad range can be included in the artistic design of film recordings.

It is perceived to be a disadvantage of the known image converter arrangement that the optical elements, which are disposed behind one another in linear manner in the beam path, result in a relatively long and heavy construction. Another particular feature of the known image converter device consists in the fact that an additional image inversion in the main image plane takes place by means of using a second lens. Fundamentally, this could be compensated in relatively simple manner by using a suitable reproduction software. But since this is not available in commercially available video cameras, it has already been proposed (EP 0 950 912 A2) to use an image-inverting prism arrangement in the beam path, which can be disposed either in front of or behind the intermediate image plane. However, with this it is not possible to significantly reduce the construction length and/or the weight of the image converter optics.

Proceeding from this, the invention is based on the task of improving the known image converter arrangement of the type indicated initially, in such a manner that a significant reduction in construction length is possible, while keeping the optical properties the same.

To accomplish this task, the combinations of characteristics indicated in claims 1 and 29 are proposed. Advantageous embodiments and further developments of the invention are evident from the dependent claims.

The solution according to the invention is primarily based on the idea that a significant reduction in length of the image converter arrangement can be achieved by means of an appropriate inclusion of the prism path, with an index of refraction that is elevated as compared with air, and of deflections in the beam path of the prism arrangement. In order to achieve this, it is proposed, according to the invention, that the projection disk is positioned in an intermediate space between two prism surfaces within the prism arrangement, which surfaces face one another and are oriented parallel to one another.

According to a preferred embodiment of the invention, the projection disk is oriented in a plane within the prism arrangement that is parallel to the optical axis of the recording lens and/or of the image converter lens, with its broad side surfaces that run parallel to one another. It is particularly advantageous if the recording lens and the image converter lens are oriented axis-parallel to one another, whereby fundamentally, even a same-axis orientation is possible.

A preferred embodiment of the invention provides that the prism arrangement as a whole is configured as an optical image inverter unit. In this connection, it is practical if at least part of the prisms within the prism arrangement is combined into a prism block, whereby a gap space, delimited by two prism surfaces, is provided for the projection disk. In order to avoid contaminants in the region of the intermediate image plane, it is particularly advantageous if the projection disk is glued or cemented to an adjacent prism surface with at least one of its broad side surfaces.

The projection disk can be configured either as a matte disk or as a fiber disk. In the latter case, the fiber disk has a plurality of light guide fibers that are oriented parallel to the beam path, lie closely against one another, and are cut to the length of the disk thickness. In order to avoid interference light, it is practical if the light guide fibers of the fiber disk are shielded against scattered light from the side. It is practical if the light guide fibers form a surface grid within the projection disk, and they preferably consist of glass fibers having a light-permeable core glass and a thin-walled mantle glass having a lower index of refraction, as well as embedded black glass strands. It is advantageous if the light guide fibers have a diameter <0.01 mm, preferably <0.006 mm. It is practical if the projection disk is polished to a high shine at the broad side surfaces. The high-shine polish of the fiber ends reduces the degree of spectral transmission at the broad surfaces of the projection disk almost to the Fresnel reflection losses.

In order to improve the light yield in the prism beam path, it is proposed, according to a preferred embodiment of the invention, that at least one convex lens is disposed in the beam path in front of and/or behind the projection disk. The convex lenses can be configured as planar convex lenses or biconvex lenses, or as achromatic lenses. In this connection, the at least one convex lens can be disposed at various points within the beam path:
In the free space directly in front of and/or behind the projection disk;
in a free gap space between two prism surfaces that face one another and are oriented parallel to one another, within the prism arrangement;
in a free gap space between the recording lens and a prism surface of the prism arrangement.

It has proven to be particularly advantageous if the convex lens disposed in the beam path in front of the projection disk has a focal width of approximately ¼ of the straight-line viewing distance between the recording lens and the projection disk. On the other hand, a convex lens disposed in the beam path behind the projection disk should have a focal width of approximately ¼ of the straight-line viewing distance between the projection disk and the image converter lens.

The use of additional convex lenses in the beam path has proven to be advantageous, particularly when using fiber disks as projection disks, because there, image transmission by the projection disk with great edge and contour clarity is made possible.

According to a preferred embodiment of the invention, the prism arrangement with projection disk is disposed in an adapter housing that has an optical and a mechanical connector for a recording lens and a video camera, in each instance. In this connection, it is practical if the recording lens is configured as an interchangeable lens of a standard film camera or photo camera. In particular, interchangeable lenses of a 16 mm, 35 mm, or 70 mm film camera or a miniature camera are possibilities.

Another advantageous embodiment of the invention provides that the lens of the video camera forms the image converter lens, and that a digital image receiver, preferably configured as a CCD sensor field, is disposed in the second image plane within the video camera.

Another particular feature of the invention consists in the fact that the real main image in the second image plane has a different image size and/or a different format than the real intermediate image in the first image plane. In addition, optical means for an anamorphotic format change can be disposed in the beam path, whereby furthermore, an image processing software that supports reproduction is provided, which has a routine for compensation of the anamorphotic format change. In this way, it is possible to optionally switch between a standard image format and a wide image format (for example 4:3/16:9). The optical means for anamorphotic image conversion can be disposed in the beam path within the prism arrangement, preferably behind the projection disk. They can be formed, for example, by means of crossed cylinder lenses or appropriately ground prism surfaces within the prism arrangement. The optical means for anamorphotic image conversion can also be disposed in an image converter lens, which is preferably configured as an interchangeable lens.

In the case of simpler projection disks, it constantly happens that the light passage is disrupted by defects. This results in errors in the intermediate image, which are maintained in the imaging onto the second image plane. In order to eliminate systematic errors of this type, it is advantageous if the projection disk is displaced crosswise to the beam path or rotated, whereby an oscillating movement is practical. The rotation or displacement means used for this purpose are configured, for example, as a vibration oscillator mechanically coupled with the projection disk. In this connection, the mechanical vibration amplitude of the vibration oscillator should be greater than the fiber diameter within the projection disk.

It is practical if the essential components of the image converter arrangement according to the invention are combined in an adapter to be set onto the front of a video camera, which adapter, according to the invention, has an adapter housing, a prism arrangement situated in the adapter housing, a projection disk situated in the intermediate space between two prism surfaces of the prism arrangement that face one another, a connection opening for connecting to the lens of the video camera, as well as a connection opening for a recording lens. Accordingly, it is practical if the image converter arrangement according to the invention is used in connection with a video camera, whereby the lens of the video camera forms the image converter lens, and the image receiver of the video camera is disposed in the second image plane. The recording lens is preferably configured as an interchangeable lens of a film camera or photo camera. Interchangeable lenses of a 35 mm film camera are preferred. However, interchangeable lenses of other standard formats can also be used to advantage, such as those for a 16 mm or 70 mm film camera, or for a miniature photo camera.

In the following, the invention will be described in greater detail using an exemplary embodiment shown schematically in the drawing. This shows:

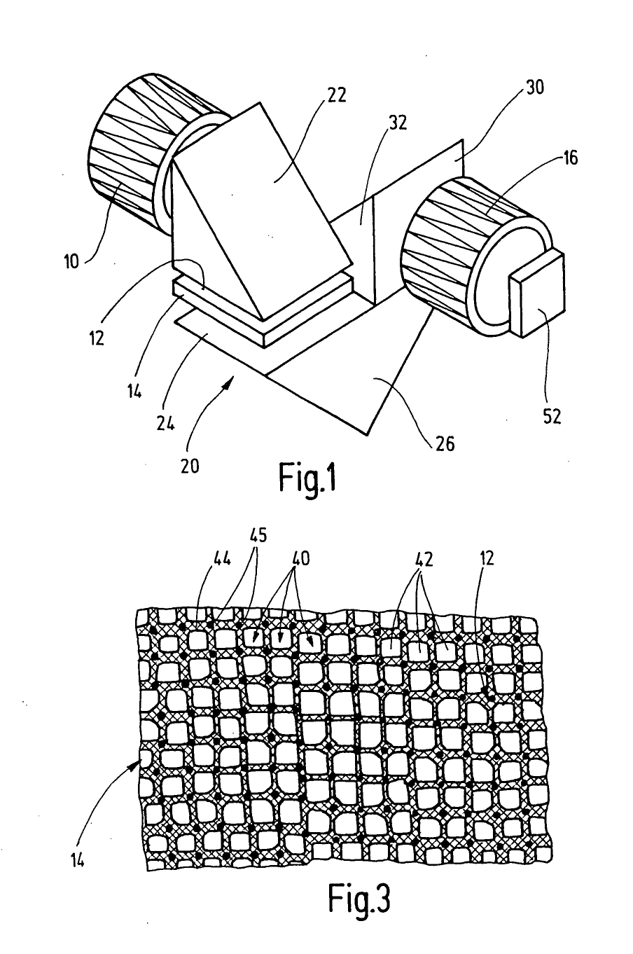

FIG. 1 an optical image converter arrangement for a video camera in an illustrative view;

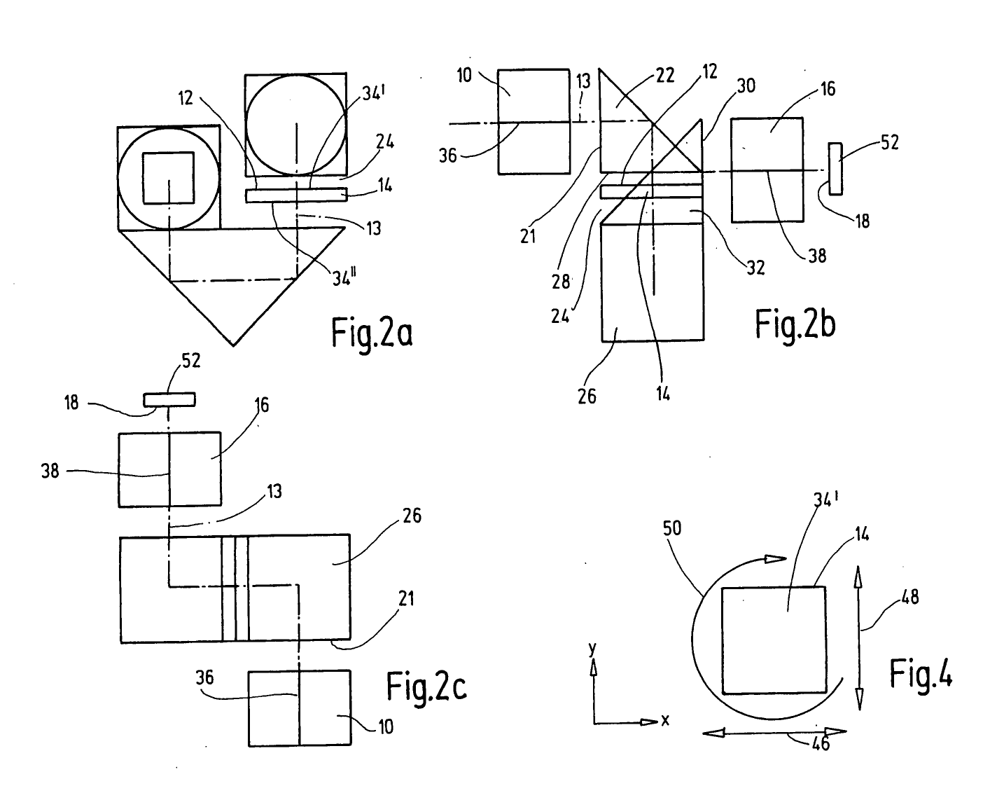

FIGS. 2a to c three side views of the image converter arrangement according to FIG. 1;

FIG. 3 a top view of the projection disk of the image converter arrangement, in a greatly magnified representation;

FIG. 4 a schematic for a moving projection disk for eliminating pass-through errors;

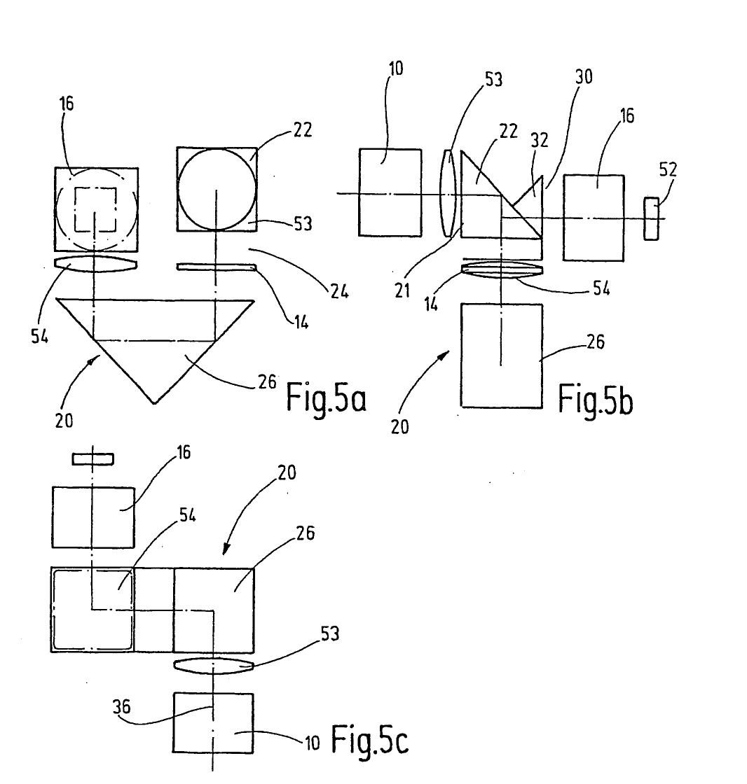

FIGS. 5a to c three side views of an image converter arrangement modified as compared with FIGS. 2a to c, having two convex lenses situated in the beam path;

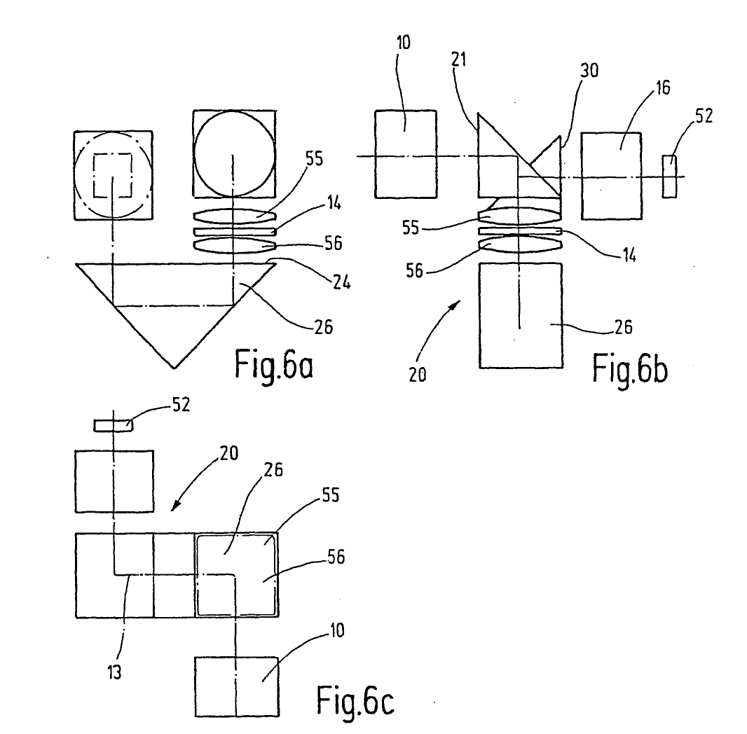

FIGS. 6a to c representations in accordance with FIGS. 5a to c for a modified image converter arrangement having two convex lenses;

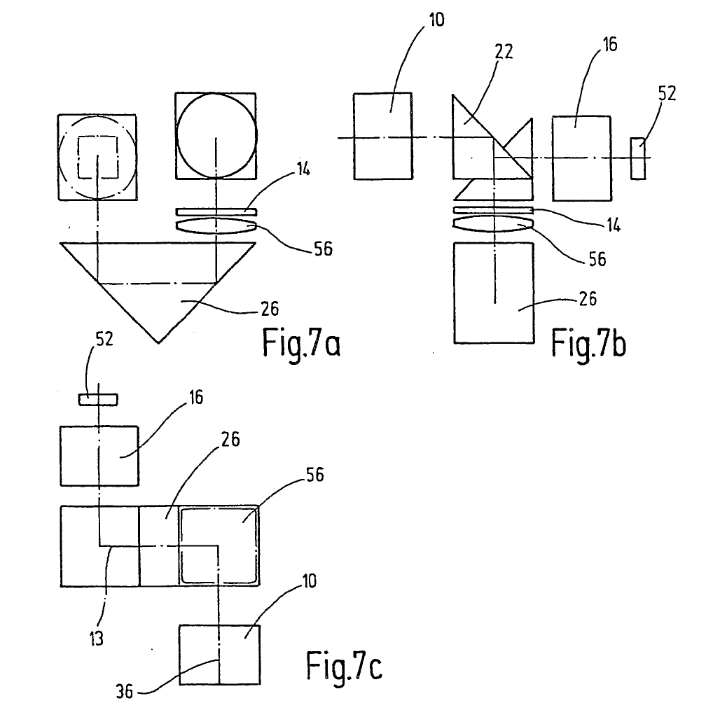

FIGS. 7a to c three side views of a modified image converter arrangement having a convex lens situated in the beam path;

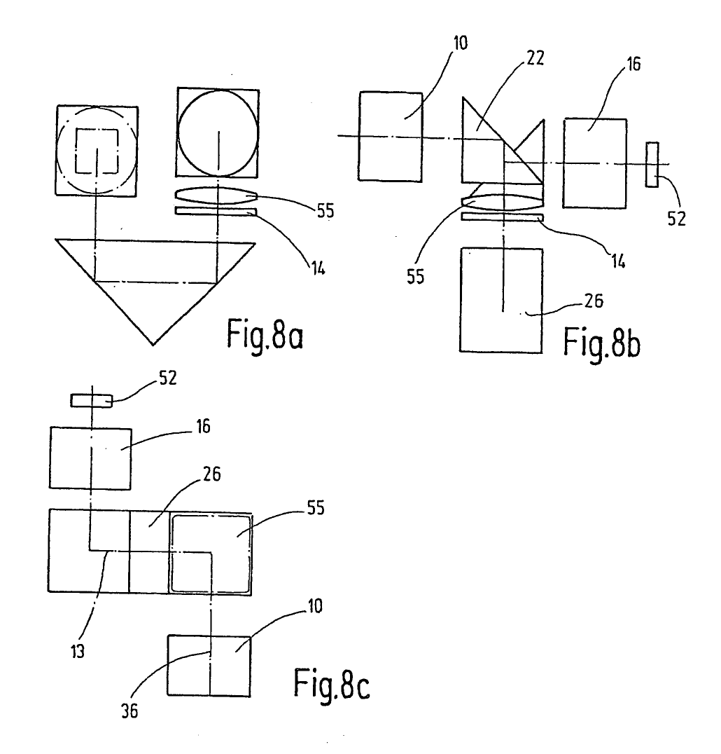

FIGS. 8a to c three side views of another image converter arrangement having a convex lens;

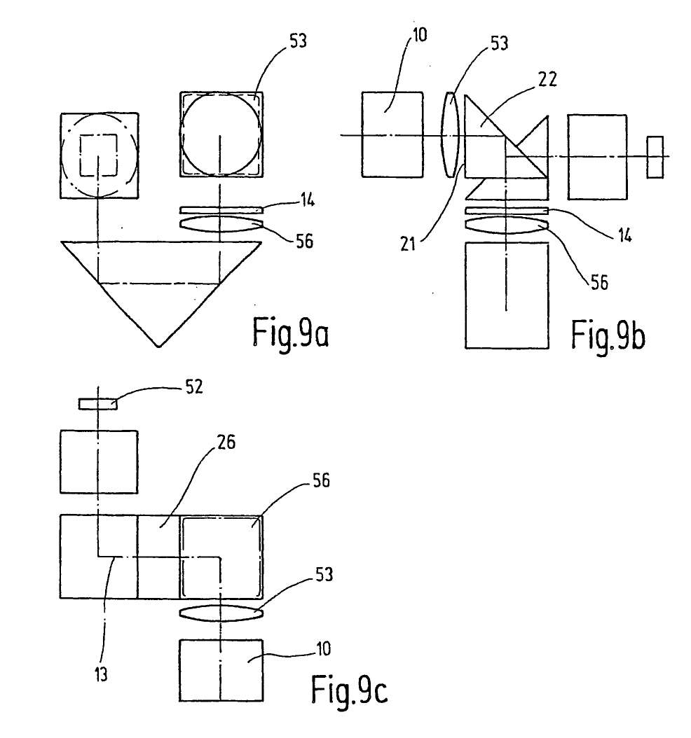

FIGS. 9a to c three side views of a modified image converter arrangement having two convex lenses.

The image converter arrangement shown in the drawing is intended for use in video cameras. It assures that commercially available camera lenses can be used to produce high-quality lens images having a depth of focus that can be adjusted within wide limits, in the image plane of the video camera.

The optical image converter arrangement comprises a recording lens 10 to be oriented towards an object, for producing a real intermediate image of the object with a defined image size and depth of focus, onto a light-permeable projection disk 14 that defines a first image plane 12. An image converter lens 16, directed at the rear of the projection disk 14, is situated in the beam path 13 behind the recording lens 10, for producing a real main image of the object in a second image plane 18, with an image size and/or image format that has been changed as compared with the intermediate image. Furthermore, a prism arrangement 20 for complete image inversion is situated in the beam path 13, having an input prism 22 facing towards the recording lens by way of an input window 21, a deflection prism coupled with the output window 26 of the input prism 22 by way of a gap space 24, an output prism 32 coupled with the deflection prism 26 with its input window 28 and facing the image converter lens 16 with its output window 30. The prisms 22, 26, and 30 can be combined with one another, at least in part, to form a prism block. The projection disk 14 is positioned in the gap space 24 between two prism surfaces that face one another and are oriented parallel to one another, within the prism arrangement 20. As can be seen, in particular, in FIG. 2b, the projection disk 14, with its broad side surfaces 34′, 34″, which are parallel to one another, is oriented within the prism arrangement 20 in a plane that is parallel to the optical axis 36 of the recording lens 10 and to the optical axis 38 of the image converter lens 16. The prism arrangement primarily serves for image inversion and for shortening the adapter length of the image converter arrangement. As can be seen in FIG. 2b and FIG. 2c, the optical axes 34, 38 of the recording lens 10 and of the image converter lens 16 are oriented parallel to one another.

Fundamentally, it is possible to configure the projection disk as a matte disk. A preferred embodiment of the invention provides that the projection disk is configured as a fiber disk, which has a plurality of light guide fibers 40 that are oriented parallel to the beam path 13, lie closely against one another, and are cut to the length of the disk thickness. The light guide fibers 40 form a surface grid within the projection disk 14 (FIG. 3). It is practical if they consist of glass fibers having a light-permeable core glass 42 and a thin-walled mantle glass 44 having a lower index of refraction. The mantle glass is not allowed to be too thin, in order to have low-loss total reflection. On the other hand, in the case of thicker mantle glass, the packing density would be less, and this would result in limited optical resolution. By means of embedding black glass 45 between the coherent fiber bundles, however, it is possible to significantly reduce the wall thickness of the mantle glass that is used. The resulting increase in packing density leads to a significant increase in optical resolution. The diameter of the light guide fibers is about 0.006 mm, so that in total, high resolution can be achieved during the imaging process. Nevertheless, there is the risk that defects within the surface grid will lead to systematic image errors in the second image plane 18. In order to eliminate the image errors, it can be advantageous to put the projection disk 14 into an oscillating or rotating crosswise movement (arrows 46, 48, 50) relative to the beam path 13 while a recording is being made. For this purpose, the projection disk 14 can be mechanically coupled with an oscillator, not shown.

In the second image plane, which is disposed within the video camera, there is an image receiver (52) configured as a CCD semiconductor field.

The exemplary embodiments shown in FIGS. 5a, b, c to 9a, b, c differ from the image converter arrangement according to FIGS. 2a to c in that in addition, at least one convex lens 53, 54, 55, 56 is disposed in the beam path of the optical image converter arrangement. The convex lenses primarily ensure that the light yield within the beam path is improved. For another thing, the lenses have the task of improving the recording quality of the secondary images with regard to edge and contour clarity, as well as freedom from graininess.

In the case of the exemplary embodiment shown in FIGS. 5a to c, a first convex lens 53 is situated in the free space between the recording lens 10 and the prism surface 21, on the input side, of the prism arrangement 20, while the second convex lens 54 is positioned in a free gap space between two prism surfaces that face one another and are oriented parallel to one another, within the prism arrangement 20. The optimal focal width of the lens 53 is ¼ of the distance between the recording lens 10 and the projection disk 14, while the focal width of the lens 54 is ¼ of the distance between the projection disk 14 and the image converter lens 16.

In the case of FIGS. 6a to c, a very compact arrangement is obtained in that one convex lens 55, 56, in each instance, are positioned in front of and behind the projection disk 14, in a common gap space 24 between two prism surfaces that face one another and are oriented parallel to one another, within the prism arrangement 20.

In the case of the exemplary embodiments according to FIGS. 7a to c and 8a to c, one of the lenses according to FIGS. 6a to c was left out, in each instance, so that there, only one lens 56 or 55, respectively, is situated in the gap space 24 between two prism surfaces, together with the projection disk 14.

The exemplary embodiment according to FIGS. 9a to c is a modification of the exemplary embodiment according to FIGS. 5a to c, in that the second lens 56 is displaced into a common gap space 24 with the projection disk 14.

In summary, the following should be stated: The invention relates to an optical image converter arrangement for use in video cameras. The image converter arrangement comprises a recording lens 10 to be oriented at an object, for producing a real intermediate image of the object, with a defined image size and depth of focus, on a light-permeable projection disk 14 that defines a first image plane 12. Furthermore, the image converter arrangement contains an image converter lens 16 disposed behind the recording lens 10 in the beam path 13, directed at the back of the projection disk 14, for producing a real main image of the object in a second image plane 18, as well as a prism arrangement 20 situated in the beam path 13. In order to obtain a compact construction of the image converter arrangement, it is proposed, according to the invention, that the projection disk 14 is positioned in an intermediate space 24 between two prism surfaces within the prism arrangement, which surfaces face one another and are oriented parallel to one another.

1: Optical image converter arrangement having a recording lens (10) to be oriented at an object, for producing a real intermediate image of the object, with a defined image size and depth of focus in a first image plane (12), having an image converter lens (16) disposed behind the recording lens (10) in the beam path (13), directed at the first image plane (12), for producing a real main image of the object in a second image plane (18), and having a prism arrangement (20) situated in the beam path (13), whereby a light-permeable projection disk is disposed in the first image plane (12), wherein the projection disk (14) is positioned in an intermediate space (24) between two prism surfaces within the prism arrangement (20), which surfaces face one another and are oriented parallel to one another.

2. Image converter arrangement according to claim 1, wherein the projection disk (14) is oriented in a plane within the prism arrangement (20) that is parallel to the optical axis (36) of the recording lens (10), with its broad side surfaces (34′, 34″) that run parallel to one another.

3. Image converter arrangement according to claim 1, wherein the projection disk (14) is oriented in a plane within the prism arrangement (20) that is parallel to the optical axis (38) of the image converter lens (16), with its broad side surfaces (34′, 34″) that run parallel to one another.

4. Image converter arrangement according to claim 1, wherein the prism arrangement (20) is configured as an optical image inverter unit.

5. Image converter arrangement according to claim 1, wherein at least part of the prisms (22, 26, 32) of the prism arrangement are combined into a prism block.

6. Image converter arrangement according to claim 5, wherein the prism block has a gap space (24) delimited by two prism surfaces, for accommodating the projection disk (14).

7. Image converter arrangement according to claim 1, wherein the projection disk (14) is polished to a high shine on its broad side surfaces.

8. Image converter arrangement according to claim 1, wherein the projection disk (14) is glued or cemented to an adjacent prism surface with at least one of its broad side surfaces (34′, 34″).

9. Image converter arrangement according to claim 1, wherein the recording lens (10) and the image converter lens (16) are oriented axis-parallel to one another.

10. Image converter arrangement according to claim 9, wherein the recording lens (10) and the image converter lens (16) are oriented with the same axis.

11. Image converter arrangement according to claim 1, wherein the projection disk (14) is configured as a matte disk.

12. Image converter arrangement according to claim 1, wherein the projection disk (14) is configured as a fiber disk that has a plurality of light guide fibers (40) that are oriented parallel to the beam path, lie closely against one another, and are cut to the length of the disk thickness.

13. Image converter arrangement according to claim 12, wherein the light guide fibers (40) of the projection disk (14) are shielded against scattered light from the side.

14. Image converter arrangement according to claim 12, wherein the light guide fibers (40) form a surface grid within the projection disk (14).

15. Image converter arrangement according to claim 12, wherein the light guide fibers (40) within the projection disk (14) are configured as glass fibers having a light-permeable core glass (42) and a thin-walled mantle glass (44) having a lower index of refraction.

16. Image converter arrangement according to claim 15, wherein black glass (45) is embedded between the glass fibers (42, 44).

17. Image converter arrangement according to claim 12, wherein the light guide fibers have a diameter <0.01 mm, preferably <0.006 mm.

18. Image converter arrangement according to claim 1, wherein at least one convex lens (53, 54, 55, 56) is disposed in the beam path in front of and/or behind the projection disk (14).

19. Image converter arrangement according to claim 18, wherein at least one of the convex lenses (55, 56) is disposed in the free space (24) directly in front of and/or behind the projection disk (14).

20. Image converter arrangement according to claim 18, wherein one of the convex lenses (54) is positioned in a free gap space between two prism surfaces within the prism arrangement (20), which surfaces face one another and are oriented parallel to one another.

21. Image converter arrangement according to claim 18, wherein one of the convex lenses (53) is positioned in a free space between the recording lens (10) and an input window (21) of the prism arrangement (20).

22. Image converter arrangement according to claim 18, wherein the convex lens (55) disposed in the beam path in front of the projection disk (14) has a focal width of approximately ¼ of the straight-line viewing distance between the recording lens (10) and the projection disk (14).

23. Image converter arrangement according to claim 18, wherein the convex lens (56) disposed in the beam path behind the projection disk has a focal width of ¼ of the straight-line viewing distance between the projection disk (14) and the image converter lens (16).

24. Image converter arrangement according to claim 1, wherein the prism arrangement (20) and the projection disk (14) are disposed in an adapter housing that has a mechanical connector for a recording lens (10) and for a video camera, in each instance.

25. Image converter arrangement according to claim 24, wherein the recording lens (10) is configured as a commercially available interchangeable lens of a film camera or a photo camera.

26. Image converter arrangement according to claim 24, wherein the lens of the video camera forms the image converter lens (16), and that an image receiver (52), preferably configured as a CCD sensor field, is disposed in the second image plane (18) within the video camera.

27. Image converter arrangement according to claim 1, wherein the real main image in the second image plane (18) has a different size and/or a different format than the real intermediate image in the first image plane (12).

28. Image converter arrangement according to claim 27, wherein optical means for an anamorphotic format change are disposed in the beam path (13), and that an image processing software that supports reproduction is provided, which has a routine for compensation of the anamorphotic format change.

29. Image converter arrangement according to claim 27, wherein the optical means for anamorphotic format change are disposed in the beam path (13) within the prism arrangement (20).

30. Image converter arrangement according to claim 29, wherein the optical means for anamorphotic format change are formed by crossed cylinder lenses or cylindrically ground prism surfaces within the prism arrangement.

31. Image converter arrangement according to claim 27, wherein the optical means for anamorphotic format change are disposed in an image converter lens (16), which is preferably configured as an interchangeable lens.

32. Image converter arrangement according to claim 1, wherein rotation or displacement means engage on the projection disk (14), for performing a rotation or displacement movement oriented crosswise to the beam path.

33. Image converter arrangement according to claim 32, wherein the rotation or displacement means are configured as a vibration oscillator mechanically coupled with the projection disk (14).

34. Image converter arrangement according to claim 33, wherein the mechanical vibration amplitude of the vibration oscillator is greater than the fiber diameter within the projection disk.

35. Adapter to be set onto the front of a video camera, having an adapter housing, having a prism arrangement (20) situated in the adapter housing, having a projection disk (14) situated in the intermediate space (24) between two prism surfaces of the prism arrangement that face one another, having a connection opening for connecting to the lens of the video camera, as well as a connection opening for connecting a recording lens (10).

36. Adapter according to claim 35, wherein the prism arrangement (20) forms an image inverter unit.

37. Adapter according to claim 35, wherein at least part of the prisms (22, 26, 32) of the prism arrangement are combined into a prism block.

38. Adapter according to claim 37, wherein the prism block has a gap space (24) delimited by two prism surfaces, for accommodating the projection disk (14).

39. Adapter according to claim 38, wherein the projection disk (14) is glued or cemented to an adjacent prism surface with at least one of its broad side surfaces.

40. Adapter according to claim 35, wherein the projection disk (14) is configured as a matte disk.

41. Adapter according to claim 35, wherein the projection disk (14) is configured as a fiber disk that has a plurality of light guide fibers (40) that are oriented parallel to the beam path (13), lie closely against one another, and are cut to the length of the disk thickness.

42. Adapter according to claim 41, wherein the light guide fibers (40) of the projection disk (14) are shielded against scattered light from the side.

43. Adapter according to claim 41, wherein the light guide fibers (40) form a surface grid within the projection disk (14).

44. Adapter according to claim 41, wherein the light guide fibers (40) within the projection disk (14) consist of glass fibers having a light-permeable core glass (42) and a thin-walled mantle glass (44) having a lower index of refraction.

45. Adapter according to claim 44, wherein black glass (45) is embedded between the glass fibers of the projection disk (14).

46. Adapter according to claim 42, wherein the light guide fibers have a diameter <0.01 mm, preferably <0.006 mm.

47. Adapter according to claim 35, wherein at least one convex lens (53, 54, 55, 56) is disposed within the prism arrangement, in front of and/or behind the projection disk (14).

48. Adapter according to claim 47, wherein at least one of the convex lenses (55, 56) is disposed in a free space (24) directly in front of and/or behind the projection disk (14).

49. Adapter according to claim 47, wherein one of the convex lenses (54) is positioned in a free gap space between two prism surfaces within the prism arrangement, which surfaces face one another and are oriented parallel to one another.

50. Adapter according to claim 47, wherein at least one of the convex lenses (53) is positioned in the adapter housing in front of the prism arrangement (20).8

51. Use of the optical image converter arrangement according to claim 1 in connection with a video camera, whereby the lens of the video camera forms the image converter lens (16) and an image receiver (52) of the video camera is disposed in the second image plane (18).

52. Use according to claim 51, wherein the recording lens (10) is configured as a commercially available interchangeable lens of a film camera or photo camera.
